(19) United States
(12) Patent Application Publication
(10) Pub. No.: US 2022/0374345 A1
(43) Pub. Date: Nov. 24, 2022

(54) TECHNIQUES FOR SIMILARITY DETERMINATION ACROSS SOFTWARE TESTING CONFIGURATION DATA ENTITIES

(71) Applicant: Infor (US), LLC, New York, NY (US)

(72) Inventors: Jeffrey Allen Brown, Colorado Springs, CO (US); Ranasinghage Piyaviraj Ranasinghe, Piliyandala (LK)

(21) Appl. No.: 17/328,908

(22) Filed: May 24, 2021

(51) Int. Cl. G06F 11/36; G06F 40/242

(52) U.S. Cl. CPC G06F 11/3688; G06F 11/3692; G06F 11/3684; G06F 40/242

(57) ABSTRACT

Various embodiments of the present invention provide methods, apparatuses, systems, computing devices, computing entities, and/or the like for similarity determination across software testing configuration data entities by using software testing configuration data entity similarity determination machine learning frameworks. In some embodiments, a method includes determining a first software testing configuration tokenized representation for the first software testing configuration data entity; identifying a second software testing configuration tokenized representation for the second software testing configuration data entity; determining the predicted similarity score based at least in part on the first software testing configuration tokenized representation and the second software testing configuration tokenized representation; and performing one or more prediction-based actions based at least in part on the predicted similarity score.

### BACKGROUND

Various embodiments of the present invention address technical challenges related to software testing and make substantial technical improvements to improving the computational efficiency, traceability, and operational reliability of both test automation platforms and manual software testing platforms. Various embodiments of the present invention make important technical contributions to the operational reliability of software applications that are tested using the software application platforms.

### BRIEF SUMMARY

In general, embodiments of the present invention provide methods, apparatuses, systems, computing devices, computing entities, and/or the like for similarity determination across software testing configuration data entities by using software testing configuration data entity similarity determination machine learning frameworks.

In accordance with one aspect, a method is provided. In one embodiment, the method comprises: determining a first software testing configuration tokenized representation for a first software testing configuration data entity, wherein the first software testing configuration tokenized representation comprises one or more first step-wise tokens for one or more first software testing configuration steps of the first software testing configuration data entity; identifying a second software testing configuration tokenized representation for a second software testing configuration data entity, wherein the second software testing configuration tokenized representation comprises one or more second step-wise tokens for one or more second software testing configuration steps of the second software testing configuration data entity; determining the predicted similarity score based on the first software testing configuration tokenized representation and the second software testing configuration tokenized representation; and performing one or more prediction-based actions based on the predicted similarity score.

In accordance with another aspect, a computer program product is provided. The computer program product may comprise at least one computer-readable storage medium having computer-readable program code portions stored therein, the computer-readable program code portions comprising executable portions configured to: determine a first software testing configuration tokenized representation for a first software testing configuration data entity, wherein the first software testing configuration tokenized representation comprises one or more first step-wise tokens for one or more first software testing configuration steps of the first software testing configuration data entity; identify a second software testing configuration tokenized representation for a second software testing configuration data entity, wherein the second software testing configuration tokenized representation comprises one or more second step-wise tokens for one or more second software testing configuration steps of the second software testing configuration data entity; determine the predicted similarity score based on the first software testing configuration tokenized representation and the second software testing configuration tokenized representation; and perform one or more prediction-based actions based on the predicted similarity score.

In accordance with yet another aspect, an apparatus comprising at least one processor and at least one memory including computer program code is provided. In one embodiment, the at least one memory and the computer program code may be configured to, with the processor, cause the apparatus to: determine a first software testing configuration tokenized representation for a first software testing configuration data entity, wherein the first software testing configuration tokenized representation comprises one or more first step-wise tokens for one or more first software testing configuration steps of the first software testing configuration data entity; identify a second software testing configuration tokenized representation for a second software testing configuration data entity, wherein the second software testing configuration tokenized representation comprises one or more second step-wise tokens for one or more second software testing configuration steps of the second software testing configuration data entity; determine the predicted similarity score based on the first software testing configuration tokenized representation and the second software testing configuration tokenized representation; and perform one or more prediction-based actions based on the predicted similarity score.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of a system that can be used to practice embodiments of the present invention;

FIG. 2 provides an example web server computing entity in accordance with some embodiments discussed herein;

FIG. 3 provides an example client computing entity in accordance with some embodiments discussed herein;

FIG. 4 is a flowchart diagram of an example process for training a software testing configuration data entity similarity determination machine learning framework in accordance with some embodiments discussed herein;

FIG. 5 provides an operational example of a JavaScript Object Notation (JSON) file for a retrieved automated testing workflow data entity in accordance with some embodiments discussed herein;

FIG. 6 provides an operational example of a set of JSON files for a set of automated testing workflow data entities in accordance with some embodiments discussed herein;

FIG. 7 provides an operational example of a token frequency matrix in accordance with some embodiments discussed herein;

FIG. 8 provides an operational example of an index file of a software testing configuration data entity similarity determination machine learning framework in accordance with some embodiments discussed herein; and

FIG. 9 is a flowchart diagram of an example process for generating a predicted similarity score for a first software testing configuration data entity and a second software testing configuration data entity in accordance with some embodiments discussed herein.

### DETAILED DESCRIPTION

Various embodiments of the present invention are described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to execute other types of data analysis.

### Overview and Technical Advantages

Various embodiments of the present invention describe techniques for reducing operational load on software testing platforms by enabling end users to use those software testing configuration data entities that are deemed similar to an input software testing configuration data entity. For example, various embodiments of the present invention provide techniques for comparing software testing configuration data entities that utilize software testing configuration tokenized representations of the noted software testing configuration data entities. By utilizing the noted techniques, various embodiments of the present invention enable generating a prompt to an end user that enables the end user to edit a software testing configuration data entity that is deemed similar to the input software testing configuration entity. By doing so, the end user will generate fewer operations that the software testing platform is configured to handle, a feature that in turn reduces the operational load on the software testing platform.

In addition, various embodiments of the present invention increase efficiency of automated testing by reducing the duplication of effort for an individual or across a team of automation engineers. Rather than wasting time to see if a software testing configuration data entity is already built in a library of software testing configuration data entities, the typical user will simply create the new software testing configuration data entity based on existing software testing configuration data entities. This is because, in a typical test case management system or automated testing script library, it takes too much time and effort for humans to find the closest match. As the library grows, this problem worsens. Using various embodiments of the present invention, the automation engineers or business analysts can quickly identify duplicate work and adjust accordingly by either stopping what they are doing, because the need has already been addressed, or by selecting the closest match and making slight modifications to meet their need. In some embodiments, the larger the library grows, the more value the techniques described herein add because there is less duplication of effort, developer time is spent on the right things, and as the library grows the system can generate more matches across software testing configuration data entities.

Furthermore, various embodiments of the present invention enable completeness of libraries of software testing configuration data entities. If an input software testing configuration data entity does not have a predicted similarity across a library, this indicates to the user that they likely have very low test coverage in this area of the application being tested and they likely need to put additional focus in testing the portion of the application which has low similarity.

Moreover, various embodiments of the present invention enable generating more reliable software testing configuration data entities by using existing software testing configuration data entities, which in turn reduces the number of erroneous testing operations performed using the noted software testing configuration data entities. In some embodiments, by reducing the number of erroneous testing operations by generating more reliable software testing configuration data entities, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing.

### Definitions of Certain Terms

The term “test case data entity” may refer to a data construct that is configured to describe data associated with a test case, where the test case may in turn describe a specification of the inputs, execution conditions, testing procedure, and expected results (e.g., including explicitly defined assertions as well as implicitly generated expected results such as the expected result that typing a value into a field causes the value to appear in the field) that define a test that is configured to be executed to achieve a particular software testing objective, such as to exercise a particular program path or to verify compliance with a specific operational requirement. In some embodiments, the test case data entity may be configured to describe test case data (e.g., webpage sequence data, user interaction sequence data, application programming interface (API) call sequence data, and/or the like) associated with a corresponding test case. In some embodiments, a test case data entity is configured to describe: (i) one or more test case page images associated with the test case, and (ii) for each test case page image of the one or more test case page images, a set of test case steps that relate to the test case page image.

The term “test case page image” may refer to a data construct that is configured to describe an image associated with a state of a webpage that is visited during a test. For example, in some embodiments, a test case page image may depict a webpage image that is determined based at least in part on a session data entity associated with the test case data entity (as further described below). As another example, in some embodiments, a test case page image may depict a user-uploaded and/or user-selected image that is configured to depict a state of a webpage associated with a corresponding test case data entity. In some embodiments, each visited webpage associated with a test case data entity may be associated with more than one test case page image, where each test case page image may depict a different state of the visited webpage. For example, consider a webpage that includes a dropdown menu interactive page element. In the noted example, some test case page images associated with the webpage may depict a visual state of the webpage in which the dropdown menu interactive page element is in a non-expanded state, while other test case page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some test case page images associated with the webpage may depict a visual state of the webpage in which the transitory notifications are displayed, while other test case page images associated with the webpage may depict a visual state of the webpage in which the transitory notifications are not displayed.

The term “test case step” may refer to a data construct that is configured to describe a user action required by a test associated with a corresponding test case data entity, where the user action may be performed with respect to an interactive page element of a webpage associated with a test case page image of the corresponding test case data entity. In some embodiments, a test case step may be associated with test case data used to generate at least one of the following: (i) a visual element identifier overlaid on the test case page image in an overlay location associated with a region of the test case page image that corresponds to the interactive page element for the test case step (e.g., is defined in relation to the interactive page element, for example is placed at the upper left of the interactive page element); and (ii) a test case step action feature that describes one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions performed with respect to interactive page elements of a webpage associated with the user action; and (iv) a user action time of the user action that may describe a captured time of the corresponding user action, and/or the like.

The term “automated testing workflow data entity” may refer to a data construct that is configured to describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

The term “automated testing workflow step” may refer to a data construct that is configured to describe a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions executed with respect to interactive page elements of a webpage associated with the user action; and (iv) a user action time of the user action that may describe a captured time of the corresponding user action, and/or the like.

The term “software testing configuration data entity” may refer to a data construct that is configured to describe steps of a software testing procedure using software testing configuration steps. Therefore, any data entity that describes one or more steps of a software testing procedure can be compared to other data entities describing one or more steps of another software testing procedure according to at least some embodiments of the invention described herein. Examples of software testing configuration data entities include test case data entities and automated testing workflow data entities, as those terms are further described below. Examples of software testing configuration steps include test case steps of a test case data entity and automated testing workflow steps of an automated testing workflow data entity, as those terms are described in greater detail below.

The term “software testing configuration step” may refer to a data construct that is configured to describe a component of a software testing configuration data entity that describes a software testing operation in a software testing procedure that is associated with the software testing configuration data entity. Examples of software testing configuration steps include test case steps of a test case data entity and automated testing workflow steps of an automated testing workflow data entity, as those terms are further described below.

The term “software testing configuration tokenized representation” may refer to a data construct that is configured to describe a text representation for a software testing configuration data entity. For example, in some embodiments, when a software testing configuration data entity is a test case data entity, the software testing configuration tokenized representation for the noted software testing configuration data entity may describe a text representation of the test case data entity as a sequence of words/phrases. As another example, when a software testing configuration data entity is an automated testing workflow data entity, the software testing configuration tokenized representation for the noted software testing configuration data entity may describe a text representation of the automated testing workflow data entity as a sequence of words/phrases. In some embodiments, the software testing configuration tokenized representation for a corresponding software testing configuration data entity may describe a sequence of step-wise tokens, where each step-wise token describes a text representation of a software testing configuration step that is associated with the corresponding software testing configuration data entity. For example, in some embodiments, when a software testing configuration data entity is a test case data entity, the software testing configuration tokenized representation for the noted software testing configuration data entity may describe a sequence of text representations of the test case steps associated with the test case data entity as a sequence of words/phrases. As another example, in some embodiments, when a software testing configuration data entity is an automated testing workflow data entity, the software testing configuration tokenized representation for the noted software testing configuration data entity may describe a sequence of text representations of the automated testing workflow steps associated with the automated testing workflow data entity as a sequence of words/phrases.

The term “step-wise token” may refer to a data construct that is configured to describe a text representation of a corresponding software testing configuration step of a corresponding software testing configuration data entity (e.g., a text representation of a corresponding test case step of a corresponding test case data entity and/or a text representation of a corresponding automated testing workflow step of a corresponding automated testing workflow data entity). For example, given a software testing configuration data entity that describes the software testing operation of clicking on a submit button, the step-wise token of the noted software testing configuration step may be clickSubmitButton. In some embodiments, the text representation of a software testing configuration step may describe a custom text string that is configured to describe a particular action type with respect to a particular interactive page element. For example, in some embodiments, if the software testing operation that is associated with clicking on a button is associated with the custom text string abcdef, then a software testing configuration step that is associated with the noted software testing operation may have a step-wise token that describes the custom text string abcdef. In some embodiments, the step-wise tokens associated with software testing configuration steps of a software testing configuration data entity are combined to generate the software testing configuration tokenized representation for the noted software testing configuration data entity. For example, step-wise tokens associated with test case steps of a test case data entity may be combined to generate a software testing configuration tokenized representation for the noted test case data entity. As another example, step-wise tokens associated with test case steps of an automated testing workflow data entity may be combined to generate a software testing configuration tokenized representation for the noted automated testing workflow data entity.

The term “token frequency data entity” may refer to a data construct that is configured to describe a frequency measure for at least some of the step-wise tokens in a software testing configuration tokenized representation for a corresponding software testing configuration data entity. For example, in some embodiments, a token frequency data entity for a corresponding software testing configuration data entity is a bag of words data entity that describes a bag of words representation of the software testing configuration tokenized representation for the corresponding software testing configuration data entity. As another example, in some embodiments, a token frequency data entity for a corresponding software testing configuration data entity is an index token frequency data entity that describes, for each index token of a set of defined index tokens, a measure of frequency (e.g., an occurrence count) of the index token in the software testing configuration tokenized representation for the corresponding software testing configuration data entity. As yet another example, in some embodiments, a token frequency data entity for a corresponding software testing configuration data entity is an index token frequency data entity that describes, for each index token of a set of defined index tokens, a Term Frequency-Index Domain Frequency (TF-IDF) measure for the index token in the software testing configuration tokenized representation for the corresponding software testing configuration data entity relative to the software testing configuration tokenized representations of the software testing configuration data entity across a corpus of software of testing configuration data entities (e.g., across a corpus of existing software testing configuration data entities retrieved as part of training a software testing configuration data entity similarity determination machine learning framework, as further described herein).

The term “low-dimensional tokenized representation” may refer to a data construct that is configured to describe a dimensionally-reduced representation of a token frequency data entity for a corresponding software testing configuration data entity, such as a dimensionally-reduced representation of an index frequency for the corresponding software testing configuration data entity and/or a dimensionally-reduced representation of a bag of words data entity for the corresponding software testing configuration data entity. In some embodiments, determining a low-dimensional tokenized representation of a corresponding software testing configuration data entity includes determining an index token frequency data entity for the software testing configuration data entity, wherein the index token frequency data entity describes a token occurrence count for each index token of a plurality of index tokens across the first software testing configuration tokenized representation; and determining the low-dimensional tokenized representation based at least in part on the index token frequency data entity. In some of the noted embodiments, determining the low-dimensional tokenized representation based at least in part on the index token frequency data entity comprises applying latent semantic indexing to the index token frequency data entity in order to generate the low-dimensional tokenized representation. In some embodiments, determining a low-dimensional tokenized representation of a corresponding software testing configuration data entity includes determining a bag of words data entity for the software testing configuration data entity; and determining the low-dimensional tokenized representation based at least in part on the bag of words data entity. In some of the noted embodiments, determining the low-dimensional tokenized representation based at least in part on the bag of words data entity comprises applying latent semantic indexing to the bag of words data entity in order to generate the low-dimensional tokenized representation.

The term “software testing configuration data entity similarity determination machine learning framework” may refer to a data construct that is configured to describe a collection of machine learning models that are configured to process two software testing configuration data entities in order to generate a predicted similarity score for the two software testing configuration data entities. In some embodiments, a software testing configuration data entity is configured to process two software testing configuration data entities by generating software testing configuration tokenized representations of the two software testing configuration data entities and generating the predicted similarity score for the two software testing configuration data entities based at least in part on the software testing configuration tokenized representations for the two software testing configuration data entities. In some embodiments, a software testing configuration data entity similarity determination machine learning framework comprises a set of files that are generated as a result of performing latent semantic indexing. In some of the noted embodiments, the set of includes at least one of the following: a dictionary file that is configured to enable generating low-dimensional tokenized representations for software testing configuration data entities based at least in part on token frequency data entities for the software testing configuration data entities, a model file that is configured to describe low-dimensional tokenized representations of the existing software testing configuration data entities, and an index file that describes, for each existing software testing configuration data entity, top n existing software testing configuration data entities that are deemed most similar to the noted existing software testing configuration data entity (where n may be a tuned/preconfigured hyper-parameter of a web server system that is configured to utilize a software testing configuration data entity similarity determination machine learning framework to generate predicted similarity scores).

The term “dictionary file” may refer to a data construct that is configured to describe a component of a software testing configuration data entity similarity determination machine learning framework that comprises guidelines/rules that are configured to enable mapping token frequency data entities of software configuration data entities into low-dimensional tokenized representations of software configuration data entities. In some embodiments, a model file is a component of a software testing configuration data entity similarity determination machine learning framework. In some embodiments, an index file is generated by a latent semantic indexing routine.

The term “index file” may refer to a data construct that is configured to describe a component of a software testing configuration data entity similarity determination machine learning framework that comprises guidelines/rules that describe, for each existing software testing configuration data entity, top n existing software testing configuration data entities that are deemed most similar to the noted existing software testing configuration data entity (where n may be a tuned/preconfigured hyper-parameter of a web server system that is configured to utilize a software testing configuration data entity similarity determination machine learning framework to generate predicted similarity scores). In some embodiments, an index file is a component of a software testing configuration data entity similarity determination machine learning framework. In some embodiments, an index file is generated by a latent semantic indexing routine. In some embodiments, an existing software testing configuration data entity whose top n most similar software testing configuration data entities are described by an index file is referred to herein as an indexed software testing configuration data entity.

The term “predicted similarity score” may refer to a data construct that is configured to describe a measure of similarity of a pair of software testing configuration data entities. In some embodiments, determining the predicted similarity score comprises determining a first low-dimensional tokenized representation of the first software testing configuration tokenized representation; identifying a second low-dimensional tokenized representation of the second software testing configuration tokenized representation; and determining the predicted similarity score based at least in part on the first low-dimensional tokenized representation and the second low-dimensional tokenized representation. In some embodiments, determining the predicted similarity score based at least in part on the first low-dimensional tokenized representation and the second low-dimensional tokenized representation comprises determining the predicted similarity score based at least in part on a cosine similarity of the first low-dimensional tokenized representation and the second low-dimensional tokenized representation. In some embodiments, determining the predicted similarity score based at least in part on the first low-dimensional tokenized representation and the second low-dimensional tokenized representation comprises determining the predicted similarity score based at least in part on a dot product similarity of the first low-dimensional tokenized representation and the second low-dimensional tokenized representation.

The term “execution plan data entity” may refer to a data construct that is configured to describe a collection of test case data entities. For example, an execution plan data entity may describe a set of test case data entities that are generated based at least in part on a set of execution plan definition tags. In some embodiments, when an execution plan data entity is determined based at least in part on a set of test case data entities that are generated based at least in part on set of execution plan definition tags, the execution plan data entity may be referred to herein as a “dynamic execution plan data entity.” As another example, an execution plan data entity may describe a set of test case data entities that are explicitly selected by an end user of a web server computing entity. In some embodiments, when an execution plan data entity describes a set of test case data entities that are explicitly selected by an end user of a web server computing entity, the execution plan data entity may be referred to herein as a “static execution plan data entity.” Moreover, as described herein, the set of test case data entities described by an execution plan data entity may be referred to as the planned test case subset for the execution plan data entity. In some embodiments, execution plan data entities include worksheet execution plan data entities that are generated based at least in part on previously-documented execution run data entities, as further described below.

The term “execution run data entity” may refer to a data construct that is configured to describe a defined execution of an execution plan data entity, such as a defined automated execution of an execution plan data entity. In some embodiments, when an execution run data entity describes an automated execution of an execution plan data entity, the execution run data entity is referred to herein as an “automated execution run data entity.” In some embodiments, an execution run data entity is determined based at least in part on a set of execution run definition parameters for the execution run data entity, such as an execution run automation parameter for the execution run data entity that describes whether the execution run data entity is an automated execution run data entity; an execution run scheduling parameter for the execution run data entity that describes whether the execution run data entity should be executed once, periodically (e.g., in accordance with a defined periodicity), or in an on-demand manner as demanded by end users; an execution run parallelization parameter for the execution run data entity that describes whether the execution run data entity should be performed sequentially or in parallel; and an execution run web environment parameter for the execution run data entity that describes the Uniform Resource Locator (URL) for a base (i.e., starting) webpage of the execution run data entity.

### Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage median include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to execute certain steps or operations. Thus, embodiments of the present invention may also take the form of an entirely hardware embodiment, an entirely computer program product embodiment, and/or an embodiment that comprises combination of computer program products and hardware executing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be executed sequentially such that one instruction is retrieved, loaded, and executed at a time. In some exemplary embodiments, retrieval, loading, and/or execution may be executed in parallel such that multiple instructions are retrieved, loaded, and/or executed together. Thus, such embodiments can produce specifically-configured machines executing the steps or operations specified in the block diagrams and flowchart illustrations. Accordingly, the block diagrams and flowchart illustrations support various combinations of embodiments for executing the specified instructions, operations, or steps.

### Exemplary System Framework

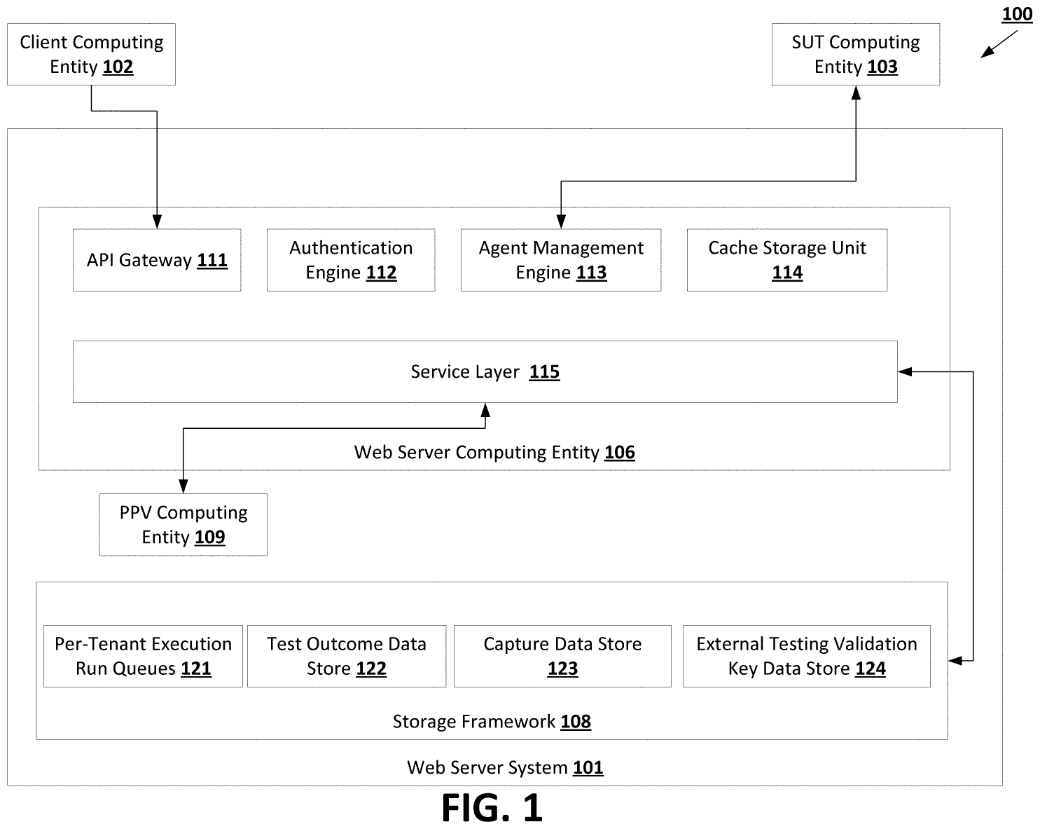

FIG. 1 depicts an architecture 100 for managing multi-tenant execution of a group of automated execution run data entities associated with a plurality of test automation tenants, while enabling a similarity determination across software testing configuration data entities. The architecture 100 that is depicted in FIG. 1 includes the following: (i) a web server system 101 comprising a web server computing entity 106, a storage framework 108, and a post-production validation (PPV) computing entity 109; (ii) one or more client computing entities such as the client computing entity 102; and (iii) and one or more system under test (SUT) computing entities such as the SUT computing entity 103.

In some embodiments, the web server computing entity 106 is configured to: (i) receive execution run data entities from the client computing entities and execute software testing operations corresponding to the execution run data entities by interacting with the SUT computing entities 103; and (ii) validate software testing platforms by installing the software testing platforms on the PPV computing entity 109 and checking whether the installed software testing platforms comply with platform requirements (e.g., customer-specified platform requirements). The web server computing entity 106 may be configured to receive execution run data entities from the client computing entities using the application programming (API) gateway 111 that may be an Amazon API Gateway. The web server computing entity 106 may further be configured to validate execution run data entities using the Authentication Engine 112, which may be an Amazon Web Services (AWS) Lambda Authentication Filter. The web server computing entity 106 may be further configured to execute software testing operations corresponding to execution run data entities by using automated testing execution agents generated and maintained by an agent management engine 113, where the agent management engine 113 may be configured to generate and maintain automated testing execution agents based at least in part on autoscaling routines and agent throttling concepts discussed herein.

The web server computing entity 106 may be further configured to maintain a cache storage unit 114 (e.g., a Redis cache) to maintain execution data associated with executing software testing operations corresponding to the execution run data entities by interacting with the SUT computing entities 103 and/or execution data associated with validating software testing platforms by installing the software testing platforms on the PPV computing entity 109 and checking whether the installed software testing platforms comply with platform requirements (e.g., customer-specified platform requirements).

The web server computing entity 106 may in some embodiments comprise a service layer 115, where the service layer 115 is comprised to maintain at least one of the following in the storage framework 108: (i) a set of per-tenant execution run queues 121 (as further described below); (ii) a test outcome data store 122 storing data describing which software testing operations have succeeded or failed; (iii) a capture data store 123 storing data related to captured page images generated while performing software testing operations; and (iv) an external testing validation key data store 124 storing external testing validation keys for external automated testing execution agents.

### Exemplary Web Server Computing Entity

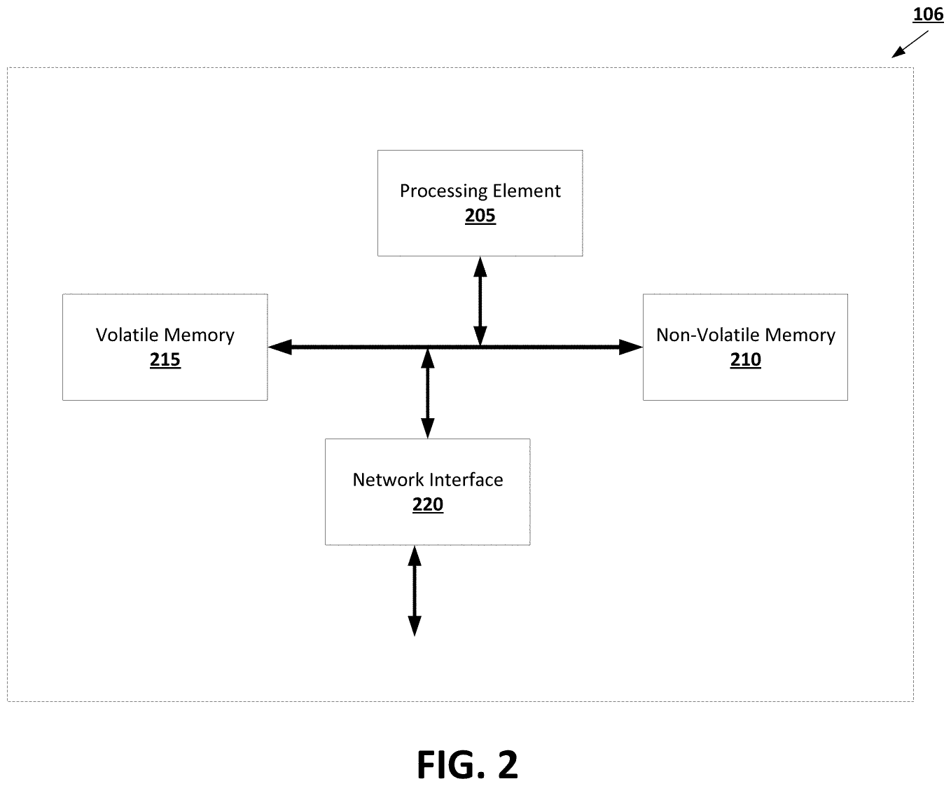

FIG. 2 provides a schematic of a web server computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to execute the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be executed on data, content, information, and/or similar terms used herein interchangeably. While FIG. 2 is described with reference to the web server computing entity 106, a person of ordinary skill in the relevant technology will recognize that the depicted architecture can be used in relation to SUT computing entities and PPV computing entities.

As indicated, in one embodiment, the web server computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the web server computing entity 106 may include, or be in communication with, one or more processing elements 205 (also referred to as processors, processing circuitry, and/or similar terms used herein interchangeably) that communicate with other elements within the web server computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of executing steps or operations according to embodiments of the present invention when configured accordingly.

In one embodiment, the web server computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the web server computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the web server computing entity 106 with the assistance of the processing element 205 and operating system.

As indicated, in one embodiment, the web server computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the web server computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the web server computing entity 106 may include, or be in communication with, one or more input elements, such as a keyboard input, a mouse input, a touch screen/display input, motion input, movement input, audio input, pointing device input, joystick input, keypad input, and/or the like. The web server computing entity 106 may also include, or be in communication with, one or more output elements (not shown), such as audio output, video output, screen/display output, motion output, movement output, and/or the like.

### Exemplary Client Computing Entity

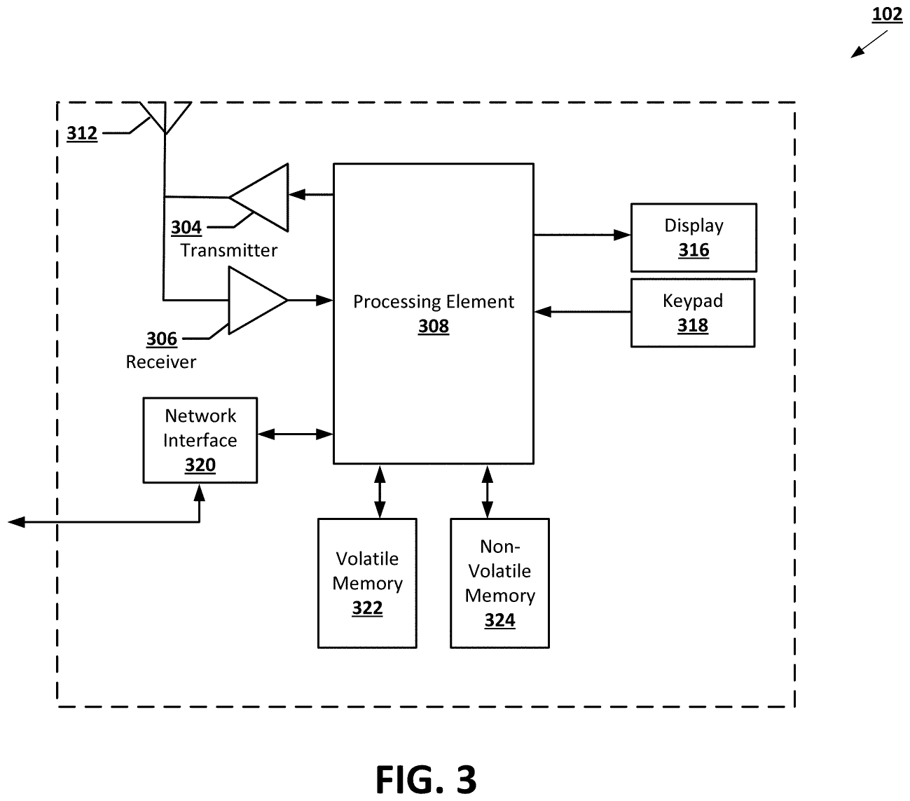

FIG. 3 provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the web server computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the web server computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the web server computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the web server computing entity 106 and/or various other computing entities.

In another embodiment, the client computing entity 102 may include one or more components or functionality that are the same or similar to those of the web server computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Exemplary System Operations

Provided below are techniques for comparing software testing configuration data entities that utilize software testing configuration tokenized representations of the noted software testing configuration data entities. Examples of software testing configuration data entities include test case data entities and automated testing workflow data entities. Therefore, the techniques described herein for comparing software testing configuration data entities can be used to compare test case data entities and/or to compare automated testing workflow data entities. Before proceeding to describe the noted techniques, we will describe exemplary embodiments of what software testing configuration data entities may be and exemplary embodiments of what software testing configuration data entities may entail.

In general, a software testing configuration data entity may describe steps of a software testing procedure using software testing configuration steps. Therefore, any data entity that describes one or more steps of a software testing procedure can be compared to other data entities describing one or more steps of another software testing procedure according to at least some embodiments of the invention described herein. Examples of software testing configuration data entities include test case data entities and automated testing workflow data entities, as those terms are further described below. Examples of software testing configuration steps include test case steps of a test case data entity and automated testing workflow steps of an automated testing workflow data entity, as those terms are further described below.

In some embodiments, a software testing configuration data entity may be a test case data entity, which may describe data associated with a test case, where the test case may in turn describe a specification of the inputs, execution conditions, testing procedure, and expected results (e.g., including explicitly defined assertions as well as implicitly generated expected results such as the expected result that typing a value into a field causes the value to appear in the field) that define a test that is configured to be executed to achieve a particular software testing entity, such as to exercise a particular program path or to verify compliance with a specific operational requirement. In some embodiments, the test case data entity may be configured to describe test case data (e.g., webpage sequence data, user interaction sequence data, application programming interface (API) call sequence data, and/or the like) associated with a corresponding test case. In some embodiments, a test case data entity is configured to describe: (i) one or more test case page images associated with the test case, and (ii) for each test case page image of the one or more test case page images, a set of test case steps that relate to the test case page image. In some embodiments, a test case data entity includes one or more test case page images, which may describe an image associated with a state of a webpage that is visited during a test. For example, in some embodiments, a test case page image may depict a webpage image that is determined based at least in part on a session data entity associated with the test case data entity (as further described below). As another example, in some embodiments, a test case page image may depict a user-uploaded and/or user-selected image that is configured to depict a state of a webpage associated with a corresponding test case data entity. In some embodiments, each visited webpage associated with a test case data entity may be associated with more than one test case page image, where each test case page image may depict a different state of the visited webpage. For example, consider a webpage that includes a dropdown menu interactive page element. In the noted example, some test case page images associated with the webpage may depict a visual state of the webpage in which the dropdown menu interactive page element is in a non-expanded state, while other test case page images associated with the webpage may depict a visual state of the webpage in which the dropdown menu interactive page element is in an expanded state. As another example, consider a webpage that is configured to generate a transitory notification (e.g., a transitory notification that is generated in response to a defined user action, such as in response to the user hovering over an interactive page element and/or in response to the user selecting an interactive button). In the noted example, some test case page images associated with the webpage may depict a visual state of the webpage in which the transitory notifications are displayed, while other test case page images associated with the webpage may depict a visual state of the webpage in which the transitory notifications are not displayed.

In some embodiments, a software testing configuration data entity may be an automated testing workflow data entity, which may describe a sequence of web-based actions that may be executed to generate an automated testing operation associated with a software test that is configured to be executed to achieve a particular software testing objective, such as to exercise a particular program path or to verify compliance with a specific operational requirement. For example, the automated testing workflow data entity may describe a sequence of webpages associated with a software testing operation, where each webpage may in turn be associated with a set of automated testing workflow steps. The sequence of webpages and their associated automated testing workflow steps may then be used to generate automation scripts for the software testing operation, where the automation script may be executed by an execution agent in order to execute the software testing operation and generate a software testing output based at least in part on a result of the execution of the automation script. In some embodiments, an automated testing workflow data entity is determined based at least in part on a test case data entity for the corresponding software testing operation, where the test case data entity may describe data associated with a test case, where the test case may in turn describe a specification of the inputs, execution conditions, testing procedure, and expected results that define a test that is configured to be executed to achieve a particular software testing objective, such as to exercise a particular program path or to verify compliance with a specific operational requirement.

As described above, a software testing configuration data entity may describe one or more software testing configuration steps, which may be a component of a software testing configuration data entity that describes a software testing operation in a software testing procedure that is associated with the software testing configuration data entity. Examples of software testing configuration steps include test case steps of a test case data entity and automated testing workflow steps of an automated testing workflow data entity, as those terms are further described below.

In some embodiments, a test case step describes a user action required by a test associated with a corresponding test case data entity, where the user action may be performed with respect to an interactive page element of a webpage associated with a test case page image of the corresponding test case data entity. In some embodiments, a test case step may be associated with test case data used to generate at least one of the following: (i) a visual element identifier overlaid on the test case page image in an overlay location associated with a region of the test case page image that corresponds to the interactive page element for the test case step (e.g., is defined in relation to the interactive page element, for example is placed at the upper left of the interactive page element); and (ii) a test case step action feature that describes one or more action features of the user action associated with the test case step. For example, if a test case step corresponds to the user action of selecting a particular button on a particular webpage, the test case step may describe data corresponding to a visual element identifier overlaid on an image region of a test case page image for the particular webpage that corresponds to (e.g., is defined in relation to) a location of the particular button on the particular webpage. In the noted example, the test case step may describe data associated with action features of a user action that may be used to generate a test case step action feature. An action feature of a user action may describe any property of a user action that is configured to change a state and/or a value of an interactive page element within a webpage. Examples of action features for a user action include (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions performed with respect to interactive page elements of a webpage associated with the user action; and (iv) a user action time of the user action that may describe a captured time of the corresponding user action, and/or the like.

In some embodiments, an automated testing workflow step describes a user action required by a software testing operation associated with a corresponding automated testing workflow data entity, where the user action may be executed with respect to an interactive page element of a webpage associated with a captured page image of the corresponding automated testing workflow data entity. In some embodiments, an automated testing workflow step may be associated with: (i) an image region of the corresponding captured page image that corresponds to the interactive page element for the automated testing workflow step; and (ii) a workflow step action feature element that describes one or more action features of the user action associated with the automated testing workflow step. For example, if an automated testing workflow step corresponds to the user action of selecting a particular button on a particular webpage, the automated testing workflow step may describe data corresponding to an image region of a captured image for the particular webpage that corresponds to (e.g., is defined in relation to) a location of the particular button on the particular webpage. In the noted example, the automated testing workflow step may describe data associated with action features of a user action that may be used to generate a workflow step action feature element for the automated testing workflow step. An action feature of a user action may describe any property of a user action that is configured to change a state and/or a value of an interactive page element within a webpage. Examples of action features for a user action include: (i) a user action type of the user action that may describe a general input mode of user interaction with the interactive page element associated with the user action; (ii) a user input value of the user action that may describe a value provided by the user to an interactive page element; (iii) a user action sequence identifier of the user action that may describe a temporal order of the user action within a set of sequential user actions executed with respect to interactive page elements of a webpage associated with the user action; and (iv) a user action time of the user action that may describe a captured time of the corresponding user action, and/or the like.

Various embodiments of the present invention describe techniques for reducing operational load on software testing platforms by enabling end users to use those software testing configuration data entities that are deemed similar to an input software testing configuration data entity. For example, various embodiments of the present invention provide techniques for comparing software testing configuration data entities that utilize software testing configuration tokenized representations of the noted software testing configuration data entities. By utilizing the noted techniques, various embodiments of the present invention enable generating a prompt to an end user that enables the end user to edit a software testing configuration data entity that is deemed similar to the input software testing configuration entity. By doing so, the end user will generate fewer operations that the software testing platform is configured to handle, a feature that in turn reduces the operational load on the software testing platform.

Moreover, various embodiments of the present invention enable generating more reliable software testing configuration data entities, which in turn reduces the number of erroneous testing operations performed using the noted software testing configuration data entities. In some embodiments, by reducing the number of erroneous testing operations by generating more reliable software testing configuration data entities, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

In addition, various embodiments of the present invention increase efficiency of automated testing by reducing the duplication of effort for an individual or across a team of automation engineers. Rather than wasting time to see if a software testing configuration data entity is already built in a library of software testing configuration data entities, the typical user will simply create the new software testing configuration data entity based on existing software testing configuration data entities. This is because, in a typical test case management system or automated testing script library, it takes too much time and effort for humans to find the closest match. As the library grows, this problem worsens. Using various embodiments of the present invention, the automation engineers or business analysts can quickly identify duplicate work and adjust accordingly by either stopping what they are doing, because the need has already been addressed, or by selecting the closest match and making slight modifications to meet their need. In some embodiments, the larger the library grows, the more value the techniques described herein add because there is less duplication of effort, developer time is spent on the right things, and as the library grows the system can generate more matches across software testing configuration data entities.

### Generating a Software Testing Configuration Data Entity Similarity Determination Machine Learning Framework

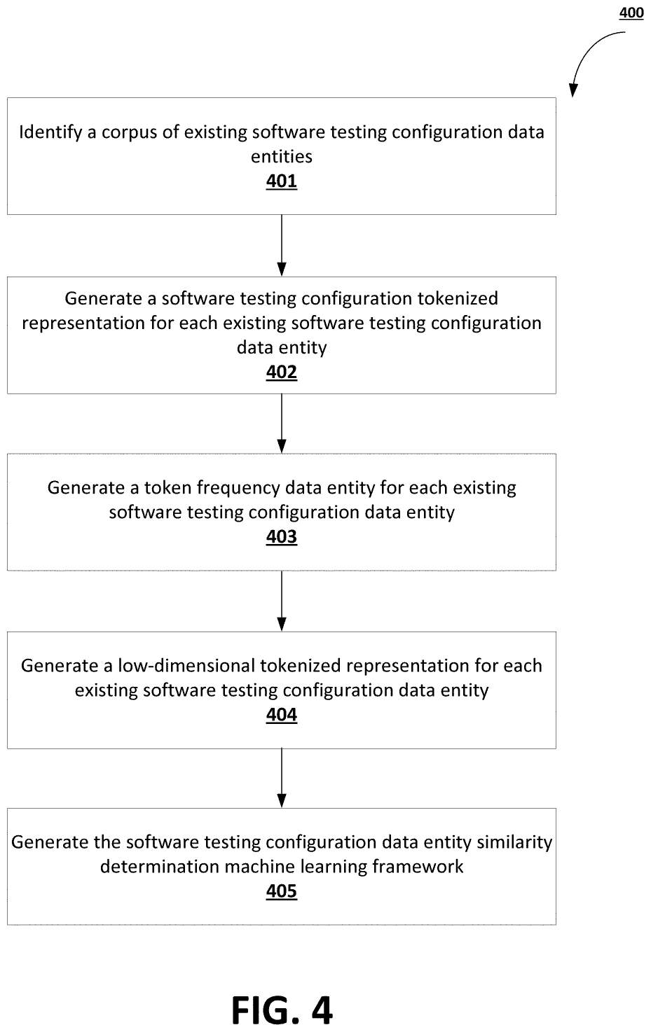

FIG. 4 is a flowchart diagram of an example process 400 for training a software testing configuration data entity similarity determination machine learning framework. Via the various steps/operations of the process 400, the web server computing entity 106 may utilize tokenized representations of software testing configuration data entities to generate a machine learning framework that can, in turn, facilitate efficient and reliable similarity determination across software testing configuration data entities.

The process 400 begins at step/operation 401 when the web server computing entity 106 identifies a corpus of existing software testing configuration data entities. In some embodiments, the corpus of existing software testing configuration data entities are retrieved from a software testing configuration data entity database (e.g., a Vista database). In some embodiments, once retrieved, the corpus of existing software testing configuration data entities are stored in an Amazon Web Services (AWS) S3 bucket.

In some embodiments, identifying an existing software testing configuration data entity comprises identifying at least one of the following data fields for each software testing configuration step of the existing software testing configuration data entity: a pageName field that describes a designation of a webpage that is associated with the software testing operation that corresponds to the software testing configuration step, an elementName field that describes a designation of an interactive page element of the webpage that is associated with the software testing operation that corresponds to the software testing configuration step, a screenShotId array field that describes one or more numeric identifiers of one or more captured page images of the webpage that is associated with the software testing operation that corresponds to the software testing configuration step, an action field that describes an action type of a software testing operation that corresponds to the software testing configuration step, and a leaveAction field that describes an action type of a software testing operation that corresponds to transitioning away from interacting with the interactive page element that is associated with the software testing operation that corresponds to the software testing configuration step.

Accordingly, in some embodiments, identifying an existing software testing configuration data entity that is a test case data entity comprises identifying at least one of the following data fields for each test case step of the noted test case data entity: a pageName field that describes a designation of a webpage that is associated with the software testing operation that corresponds to the test case step, an elementName field that describes a designation of an interactive page element of the webpage that is associated with the software testing operation that corresponds to the test case step, a screenShotId array field that describes one or more numeric identifiers of one or more captured page images of the webpage that is associated with the software testing operation that corresponds to the test case step, an action field that describes an action type of a software testing operation that corresponds to the test case step, and a leaveAction field that describes an action type of a software testing operation that corresponds to transitioning away from interacting with the interactive page element that is associated with the software testing operation that corresponds to the test case step.

Moreover, in some embodiments, identifying an existing software testing configuration data entity that is an automated testing workflow data entity comprises identifying at least one of the following data fields for each automated testing workflow step of the automated testing workflow data entity: a pageName field that describes a designation of a webpage that is associated with the software testing operation that corresponds to the automated testing workflow step, an elementName field that describes a designation of an interactive page element of the webpage that is associated with the software testing operation that corresponds to the automated testing workflow step, a screenShotId array field that describes one or more numeric identifiers of one or more captured page images of the webpage that is associated with the software testing operation that corresponds to the automated testing workflow step, an action field that describes an action type of a software testing operation that corresponds to the automated testing workflow step, and a leaveAction field that describes an action type of a software testing operation that corresponds to transitioning away from interacting with the interactive page element that is associated with the software testing operation that corresponds to the automated testing workflow step.

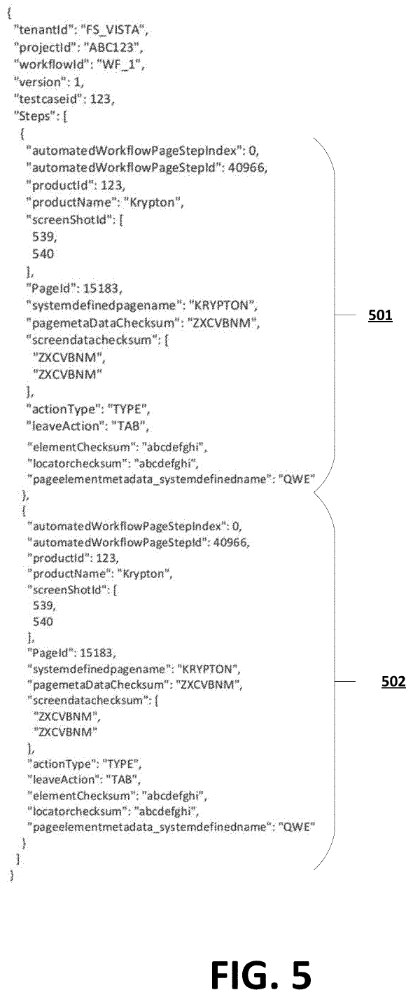

An operational example of a JavaScript Object Notation (JSON) file that describes the retrieved data fields associated with an existing software testing configuration data entity that is an automated testing workflow data entity is depicted in FIG. 5. As depicted in FIG. 5, the JSON file includes a tenantId field describing a numeric identifier of a test automation that is associated with the automated testing workflow data entity, a projectId field describing a numeric identifier of a project that is associated with the automated testing workflow data entity, a workflowId field describing a numeric identifier of the automated testing workflow data entity, a version field describing a numeric identifier of the version of the automated testing workflow data entity, and a testcaseid field describing a numeric identifier of the test case data entity that is associated with the automated testing workflow data entity.

As further depicted in FIG. 5, the JSON file includes two data fields 501-502 that each include the following data fields associated with a corresponding automated testing workflow step: an automatedWorkflowPageStepIndex field describing an index number of the automated testing workflow step, an automatedWorkflowPageStepId field describing a numeric identifier of the automated testing workflow step, a productid field describing a numeric identifier of the automated testing workflow step, a screenshotId array field describing numeric identifiers of captured page images associated with the automated testing workflow step, a pageId field describing a numeric identifier of the webpage that is associated with the automated testing workflow step, a systemdefinedpagename field describing a system-defined identifier of the webpage that is associated with the automated testing workflow step, a pagemetaDataChecksum field describing a checksum of the structure of the webpage that is associated with the automated testing workflow step, a screenndatachecksum array field describing checksums of the captured page images in the screenshotId array field, an actionType field that describes an action type of a software testing operation that corresponds to the automated testing workflow step, a leaveAction field that describes an action type of a software testing operation that corresponds to transitioning away from interacting with the interactive page element that is associated with the software testing operation that corresponds to the automated testing workflow step, an elementChecksum field that describes a checksum of the interactive page element that is associated with the software testing operation that corresponds to the automated testing workflow step, a locatorcheksum field that describes a checksum of a function for locating the interactive page element that is associated with the software testing operation that corresponds to the automated testing workflow step, and a pagelementmetadata_systemdefinedname field that describes a system-defined identifier of the metadata file for the interactive page element that is associated with the software testing operation that corresponds to the automated testing workflow step.

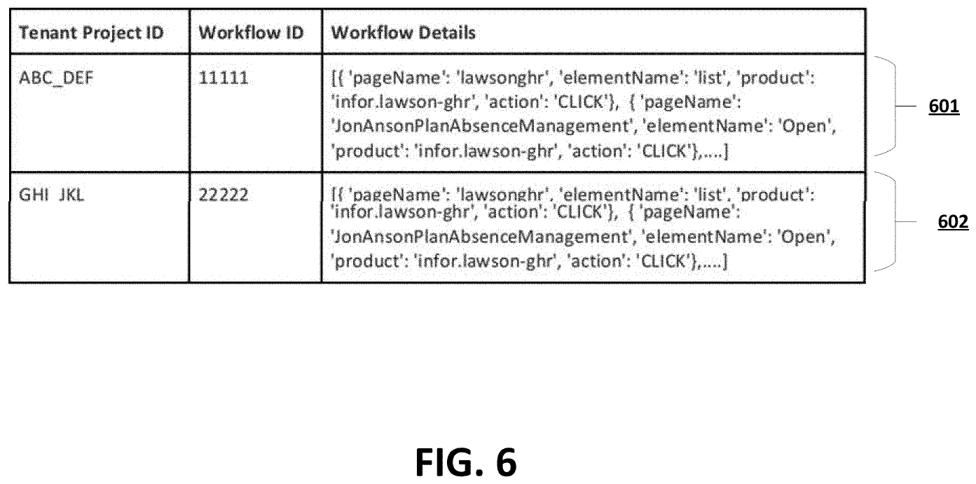

Another operational example of various JSON files 601-602 that each describe automated testing workflow steps of a corresponding automated testing workflow data entity is depicted in FIG. 6. As depicted in FIG. 6, each JSON file that is associated with a corresponding automated testing workflow data entity includes a set of JSON elements, where each JSON element describes to the following retrieved data fields for a corresponding automated testing workflow step in the corresponding automated testing workflow data entity: a pageName field that describes a designation of a webpage that is associated with the software testing operation that corresponds to the automated testing workflow step, an elementName field that describes a designation of an interactive page element of the webpage that is associated with the software testing operation that corresponds to the automated testing workflow step, a product field that describes a designator of a product that is associated with the automated testing workflow step, and an action field that describes an action type of a software testing operation that corresponds to the automated testing workflow step.

Returning to FIG. 4, at step/operation 402, the web server computing entity 106 generates a software testing configuration tokenized representation for each existing software testing configuration data entity. In some embodiments, to generate an software testing configuration tokenized representation for a corresponding existing software testing configuration data entity, the web server computing entity 106 generates a step-wise token for each of the software testing configuration steps of the corresponding existing software testing configuration data entity, and subsequently combines the step-wise tokens for the software testing configuration steps of the corresponding existing software testing configuration data entity to generate the software testing configuration tokenized representation of the corresponding existing software testing configuration data entity.

In general, a software testing configuration tokenized representation may describe a text representation for a software testing configuration data entity. For example, in some embodiments, when a software testing configuration data entity is a test case data entity, the software testing configuration tokenized representation for the noted software testing configuration data entity may describe a text representation of the test case data entity as a sequence of words/phrases. As another example, when a software testing configuration data entity is an automated testing workflow data entity, the software testing configuration tokenized representation for the noted software testing configuration data entity may describe a text representation of the automated testing workflow data entity as a sequence of words/phrases. In some embodiments, the software testing configuration tokenized representation for a corresponding software testing configuration data entity may describe a sequence of step-wise tokens, where each step-wise token describes a text representation of a software testing configuration step that is associated with the corresponding software testing configuration data entity. For example, in some embodiments, when a software testing configuration data entity is a test case data entity, the software testing configuration tokenized representation for the noted software testing configuration data entity may describe a sequence of text representations of the test case steps associated with the test case data entity as a sequence of words/phrases. As another example, in some embodiments, when a software testing configuration data entity is an automated testing workflow data entity, the software testing configuration tokenized representation for the noted software testing configuration data entity may describe a sequence of text representations of the automated testing workflow steps associated with the automated testing workflow data entity as a sequence of words/phrases.

As described above, a software testing configuration tokenized representation may include a sequence of step-wise tokens. In some embodiments, a step-wise token is a text representation of a corresponding software testing configuration step of a corresponding software testing configuration data entity (e.g., a text representation of a corresponding test case step of a corresponding test case data entity and/or a text representation of a corresponding automated testing workflow step of a corresponding automated testing workflow data entity). For example, given a software testing configuration data entity that describes the software testing operation of clicking on a submit button, the step-wise token of the noted software testing configuration step may be clickSubmitButton. In some embodiments, the text representation of a software testing configuration step may describe a custom text string that is configured to describe a particular action type with respect to a particular interactive page element. For example, in some embodiments, if the software testing operation that is associated with clicking on a button is associated with the custom text string abcdef, then a software testing configuration step that is associated with the noted software testing operation may have a step-wise token that describes the custom text string abcdef. In some embodiments, the step-wise tokens associated with software testing configuration steps of a software testing configuration data entity are combined to generate the software testing configuration tokenized representation for the noted software testing configuration data entity. For example, step-wise tokens associated with test case steps of a test case data entity may be combined to generate a software testing configuration tokenized representation for the noted test case data entity. As another example, step-wise tokens associated with test case steps of an automated testing workflow data entity may be combined to generate a software testing configuration tokenized representation for the noted automated testing workflow data entity.

At step/operation 403, the web server computing entity 106 generates a token frequency data entity for each existing software testing configuration data entity based at least in part on the software testing configuration tokenized representation for the existing software testing configuration data entity. For example, the web server computing entity 106 may generate an index token frequency data entity for an existing software testing configuration data entity based at least in part on the software testing configuration tokenized representation for the existing software testing configuration data entity. As another example, the web server computing entity 106 may generate a bag of words data entity for an existing software testing configuration data entity based at least in part on the software testing configuration tokenized representation for the noted existing software testing configuration data entity.

In some embodiments, a token frequency data entity describes a frequency measure for at least some of the step-wise tokens in a software testing configuration tokenized representation for a corresponding software testing configuration data entity. For example, in some embodiments, a token frequency data entity for a corresponding software testing configuration data entity is a bag of words data entity that describes a bag of words representation of the software testing configuration tokenized representation for the corresponding software testing configuration data entity. As another example, in some embodiments, a token frequency data entity for a corresponding software testing configuration data entity is an index token frequency data entity that describes, for each index token of a set of defined index tokens, a measure of frequency (e.g., an occurrence count) of the index token in the software testing configuration tokenized representation for the corresponding software testing configuration data entity. As yet another example, in some embodiments, a token frequency data entity for a corresponding software testing configuration data entity is an index token frequency data entity that describes, for each index token of a set of defined index tokens, a Term Frequency-Index Domain Frequency (TF-IDF) measure for the index token in the software testing configuration tokenized representation for the corresponding software testing configuration data entity relative to the software testing configuration tokenized representations of the software testing configuration data entity across a corpus of software of testing configuration data entities (e.g., across a corpus of existing software testing configuration data entities retrieved as part of training a software testing configuration data entity similarity determination machine learning framework, as further described herein).

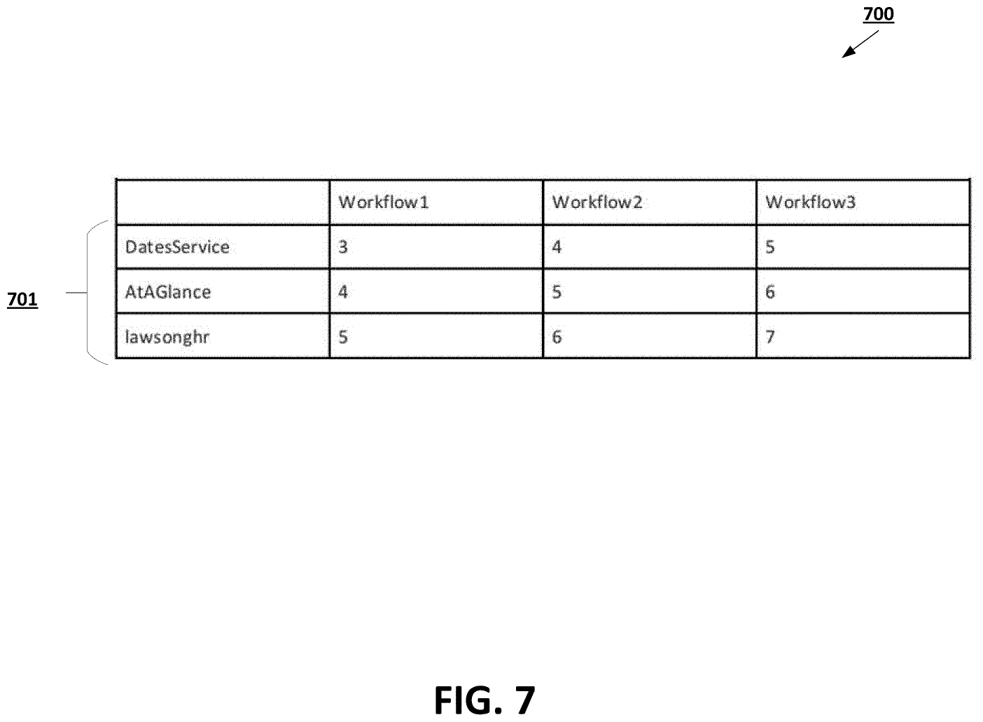

An operational example of a token frequency matrix 700 that describes occurrence counts for three index tokens 701 across a corpus of three automated testing workflow data entities is depicted in FIG. 7. As depicted in FIG. 7, each value described by the token frequency matrix 700 describes the occurrence count of a corresponding index token in a corresponding automated testing workflow data entity. For example, as depicted in FIG. 7, the index token DatesService appears three times in the automated testing workflow data entity designated as Workflow 1. As another example, as depicted in FIG. 7, the index token AtAGlance appears five times in the automated testing workflow data entity designated as Workflow 2. As yet another example, as depicted in FIG. 7, the index token lawsonghr appears seven times in the automated testing workflow data entity designated as Workflow 3.

Returning to FIG. 4, at step/operation 404, the web server computing entity 106 generates a low-dimensional tokenized representation of each existing software testing configuration data entity based at least in part on the token frequency data entity for the existing software testing configuration data entity. In some embodiments, the web server computing entity 106 applies a dimensionality reduction routine to the token frequency data entity for an existing software testing configuration data entity to generate the low-dimensional tokenized representation for the existing software testing configuration data entity. In some embodiments, the web server computing entity 106 applies a latent semantic indexing routine to the token frequency data entity for an existing software testing configuration data entity to generate the low-dimensional tokenized representation for the existing software testing configuration data entity. In some embodiments, the web server computing entity 106 generates a low-rank representation of a token frequency matrix for the existing software testing configuration data entities, such as a token frequency matrix that describes each index token frequency data entity for an existing software testing configuration data entity and/or a token frequency matrix that describes each bag of words data entity for an existing software testing configuration data entity.

In some embodiments, a low-dimensional tokenized representation may describe a dimensionally-reduced representation of a token frequency data entity for a corresponding software testing configuration data entity, such as a dimensionally-reduced representation of an index frequency for the corresponding software testing configuration data entity and/or a dimensionally-reduced representation of a bag of words data entity for the corresponding software testing configuration data entity. In some embodiments, determining a low-dimensional tokenized representation of a corresponding software testing configuration data entity includes determining an index token frequency data entity for the software testing configuration data entity, wherein the index token frequency data entity describes a token occurrence count for each index token of a plurality of index tokens across the first software testing configuration tokenized representation; and determining the low-dimensional tokenized representation based at least in part on the index token frequency data entity. In some of the noted embodiments, determining the low-dimensional tokenized representation based at least in part on the index token frequency data entity comprises applying latent semantic indexing to the index token frequency data entity in order to generate the low-dimensional tokenized representation. In some embodiments, determining a low-dimensional tokenized representation of a corresponding software testing configuration data entity includes determining a bag of words data entity for the software testing configuration data entity; and determining the low-dimensional tokenized representation based at least in part on the bag of words data entity. In some of the noted embodiments, determining the low-dimensional tokenized representation based at least in part on the bag of words data entity comprises applying latent semantic indexing to the bag of words data entity in order to generate the low-dimensional tokenized representation.

At step/operation 405, the web server computing entity 106 generates the software testing configuration data entity similarity determination machine learning framework based at least in part on each low-dimensional tokenized representation. In some embodiments, implementing latent semantic indexing creates three files: a dictionary file that is configured to enable generating low-dimensional tokenized representations for software testing configuration data entities based at least in part on token frequency data entities for the software testing configuration data entities, a model file that is configured to describe low-dimensional tokenized representations of the existing software testing configuration data entities, and an index file that describes, for each existing software testing configuration data entity, top n existing software testing configuration data entities that are deemed most similar to the noted existing software testing configuration data entity. In some embodiments, the software testing configuration data entity similarity determination machine learning framework is determined based at least in part on the dictionary file, the model file, and the index file.

In some embodiments, a software testing configuration data entity similarity determination machine learning framework describes a collection of machine learning models that are configured to process two software testing configuration data entities in order to generate a predicted similarity score for the two software testing configuration data entities. In some embodiments, a software testing configuration data entity is configured to process two software testing configuration data entities by generating software testing configuration tokenized representations of the two software testing configuration data entities and generating the predicted similarity score for the two software testing configuration data entities based at least in part on the software testing configuration tokenized representations for the two software testing configuration data entities. In some embodiments, a software testing configuration data entity similarity determination machine learning framework comprises a set of files that are generated as a result of performing latent semantic indexing. In some of the noted embodiments, the set of includes at least one of the following: a dictionary file that is configured to enable generating low-dimensional tokenized representations for software testing configuration data entities based at least in part on token frequency data entities for the software testing configuration data entities, a model file that is configured to describe low-dimensional tokenized representations of the existing software testing configuration data entities, and an index file that describes, for each existing software testing configuration data entity, top n existing software testing configuration data entities that are deemed most similar to the noted existing software testing configuration data entity (where n may be a tuned/preconfigured hyper-parameter of a web server system that is configured to utilize a software testing configuration data entity similarity determination machine learning framework to generate predicted similarity scores).

In some embodiments, a dictionary file describes guidelines/rules that are configured to enable mapping token frequency data entities of software configuration data entities into low-dimensional tokenized representations of software configuration data entities. In some embodiments, a model file is a component of a software testing configuration data entity similarity determination machine learning framework. In some embodiments, an index file is generated by a latent semantic indexing routine.

In some embodiments, an index file describes, for each existing software testing configuration data entity, top n existing software testing configuration data entities that are deemed most similar to the noted existing software testing configuration data entity (where n may be a tuned/preconfigured hyper-parameter of a web server system that is configured to utilize a software testing configuration data entity similarity determination machine learning framework to generate predicted similarity scores). In some embodiments, an index file is a component of a software testing configuration data entity similarity determination machine learning framework. In some embodiments, an index file is generated by a latent semantic indexing routine. In some embodiments, an existing software testing configuration data entity whose top n most similar software testing configuration data entities are described by an index file is referred to herein as an indexed software testing configuration data entity.

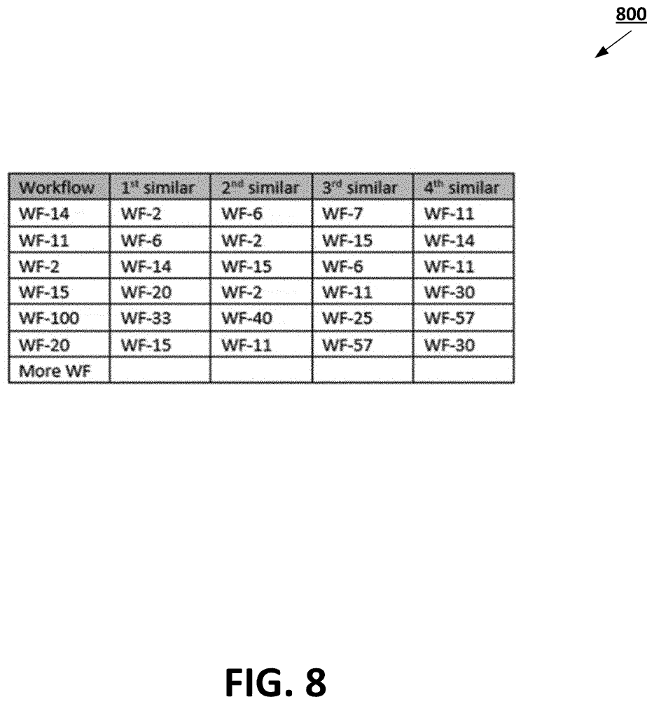

An operational example of such an index file 800 of a software testing configuration data entity similarity determination machine learning framework is depicted in FIG. 8. As depicted in FIG. 8, the index file describes, for each existing automated testing workflow data entity, a set of four existing automated testing workflow data entities (e.g., an ordered set of automated testing workflow data entities based at least in part on predicted similarity scores) that are deemed most similar to the existing automated testing workflow data entity.

For example, as depicted in FIG. 8, the automated testing workflow data entity WF-14 is associated with the following four automated testing workflow data entities that are deemed most similar to the automated testing workflow data entity WF-14: the automated testing workflow data entity WF-2, the automated testing workflow data entity WF-6, the automated testing workflow data entity WF-7, and the automated testing workflow data entity WF-11. As another example, as depicted in FIG. 8, the automated testing workflow data entity WF-11 is associated with the following four automated testing workflow data entities that are deemed most similar to the automated testing workflow data entity WF-11: the automated testing workflow data entity WF-6, the automated testing workflow data entity WF-2, the automated testing workflow data entity WF-15, and the automated testing workflow data entity WF-14. As yet another example, as depicted in FIG. 8, the automated testing workflow data entity WF-2 is associated with the following four automated testing workflow data entities that are deemed most similar to the automated testing workflow data entity WF-2: the automated testing workflow data entity WF-14, the automated testing workflow data entity WF-15, the automated testing workflow data entity WF-6, and the automated testing workflow data entity WF-11. As a further example, as depicted in FIG. 8, the automated testing workflow data entity WF-20 is associated with the following four automated testing workflow data entities that are deemed most similar to the automated testing workflow data entity WF-20: the automated testing workflow data entity WF-16, the automated testing workflow data entity WF-11, the automated testing workflow data entity WF-57, and the automated testing workflow data entity WF-30.

### Generating Predicted Similarity Scores for Software Testing Configuration Data Entities

Various embodiments of the present invention provide methods, apparatuses, systems, computing devices, computing entities, and/or the like for similarity determination across software testing configuration data entities by using software testing configuration data entity similarity determination machine learning frameworks. In some of the noted embodiments, a method includes determining a first software testing configuration tokenized representation for the first software testing configuration data entity; identifying a second software testing configuration tokenized representation for the second software testing configuration data entity; determining the predicted similarity score based at least in part on the first software testing configuration tokenized representation and the second software testing configuration tokenized representation; and performing one or more prediction-based actions based at least in part on the predicted similarity score.

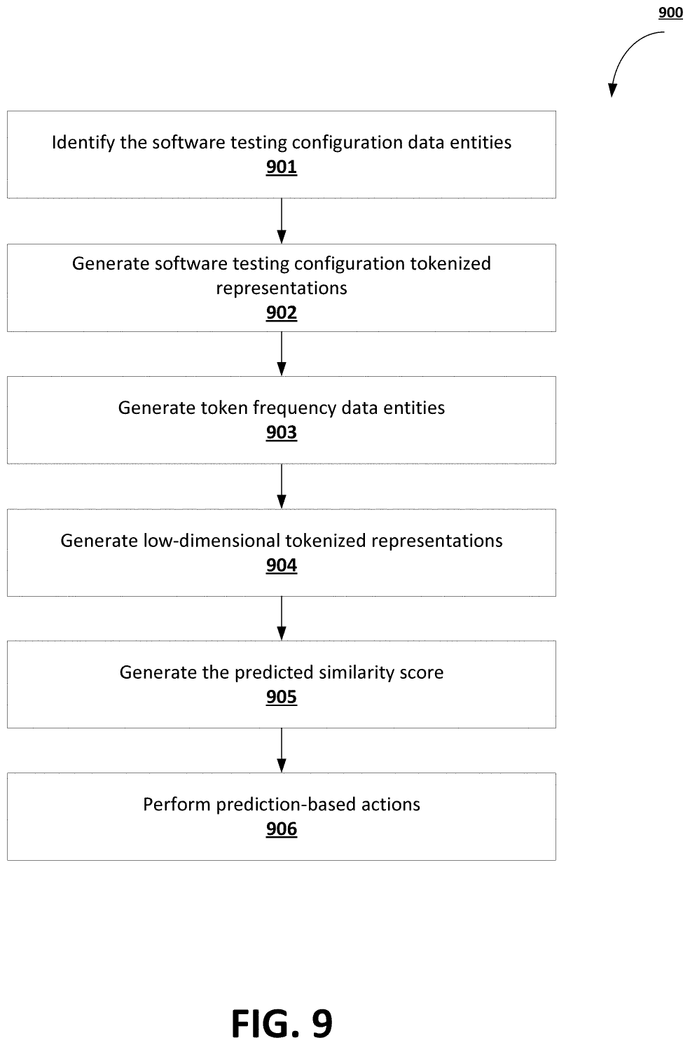

FIG. 9 is a flowchart diagram of an example process 900 for generating a predicted similarity score for a first software testing configuration data entity and a second software testing configuration data entity. Via the various steps/operations of the process 900, a web server computing entity 106 may utilize a trained/generated software testing configuration data entity similarity determination machine learning framework that to facilitate efficient and reliable similarity determination across software testing configuration data entities. While various embodiments of the present invention describe training a software testing configuration data entity similarity determination machine learning framework and utilizing a software testing configuration data entity similarity determination machine learning framework to generate predicted similarity scores across software testing configuration data entities as being performed by a single computing entity, a person of ordinary skill in the relevant technology note that each of the noted tasks (i.e., training a software testing configuration data entity similarity determination machine learning framework and utilizing a software testing configuration data entity similarity determination machine learning framework to generate predicted similarity scores across software testing configuration data entities as being performed by a single computing entity) can be performed by a separate set of one or more computing entities.

In some embodiments, the process 900 enable techniques for reducing operational load on software testing platforms by enabling end users to use those software testing configuration data entities that are deemed similar to an input software testing configuration data entity. For example, various embodiments of the present invention provide techniques for comparing software testing configuration data entities that utilize software testing configuration tokenized representations of the noted software testing configuration data entities. By utilizing the noted techniques, various embodiments of the present invention enable generating a prompt to an end user that enables the end user to edit a software testing configuration data entity that is deemed similar to the input software testing configuration entity. By doing so, the end user will generate fewer operations that the software testing platform is configured to handle, a feature that in turn reduces the operational load on the software testing platform.

The process 900 begins at step/operation 901 when the web server computing entity 106 identifies the first software testing configuration data entity and the second software testing configuration data entity. In some embodiments, the web server computing entity 106 identifies the first software testing configuration data entity based at least in part on a user query and the second software testing configuration data entity as a selected one of a corpus of existing software testing configuration data entities used to train a software testing configuration data entity similarity determination machine learning framework. Accordingly, in some embodiments of the present invention, the process 900 may be repeated across each selected existing software testing configuration data entity of at least some (e.g., all) of the corpus of existing software testing configuration data entities used to train a software testing configuration data entity similarity determination machine learning framework in order to generate predicted similarity scores for a first software testing configuration data entity defined by a user query relative to each selected existing software testing configuration data entity.

For example, in some embodiments, given a first software configuration data entity WF1 and a corpus of three existing software testing configuration data entities WF2-WF4, the process 900 may be performed once to generate the predicted similarity score for the first software configuration data entity WF1 and the existing software testing configuration data entity WF2, once to generate the predicted similarity score for the first software configuration data entity WF1 and the existing software testing configuration data entity WF3, and once to generate the predicted similarity score for the first software configuration data entity WF1 and the existing software testing configuration data entity WF4. Thus, in these embodiments, the process 900 may be performed three times to generate predicted similarity scores for the first software configuration data entity WF1 and each existing software testing configuration data entity in the corpus of three existing software testing configuration data entities WF2-WF4.

At step/operation 902, the web server computing entity 106 generates a first software testing configuration tokenized representation for the first software testing configuration data entity and a second software testing configuration tokenized representation for the second software testing configuration data entity. In some embodiments, the first software testing configuration tokenized representation comprises one or more first step-wise tokens for one or more first software testing configuration steps of the first software testing configuration data entity. In some embodiments, the second software testing configuration tokenized representation comprises one or more second step-wise tokens for one or more second software testing configuration steps of the second software testing configuration data entity.

In some embodiments, a software testing configuration tokenized representation describes a text representation for a software testing configuration data entity. For example, in some embodiments, when a software testing configuration data entity is a test case data entity, the software testing configuration tokenized representation for the noted software testing configuration data entity may describe a text representation of the test case data entity as a sequence of words/phrases. As another example, when a software testing configuration data entity is an automated testing workflow data entity, the software testing configuration tokenized representation for the noted software testing configuration data entity may describe a text representation of the automated testing workflow data entity as a sequence of words/phrases. In some embodiments, the software testing configuration tokenized representation for a corresponding software testing configuration data entity may describe a sequence of step-wise tokens, where each step-wise token describes a text representation of a software testing configuration step that is associated with the corresponding software testing configuration data entity. For example, in some embodiments, when a software testing configuration data entity is a test case data entity, the software testing configuration tokenized representation for the noted software testing configuration data entity may describe a sequence of text representations of the test case steps associated with the test case data entity as a sequence of words/phrases. As another example, in some embodiments, when a software testing configuration data entity is an automated testing workflow data entity, the software testing configuration tokenized representation for the noted software testing configuration data entity may describe a sequence of text representations of the automated testing workflow steps associated with the automated testing workflow data entity as a sequence of words/phrases.

As described above, a software testing configuration tokenized representation may include a sequence of step-wise tokens. In some embodiments, a step-wise token is a text representation of a corresponding software testing configuration step of a corresponding software testing configuration data entity (e.g., a text representation of a corresponding test case step of a corresponding test case data entity and/or a text representation of a corresponding automated testing workflow step of a corresponding automated testing workflow data entity). For example, given a software testing configuration data entity that describes the software testing operation of clicking on a submit button, the step-wise token of the noted software testing configuration step may be clickSubmitButton. In some embodiments, the text representation of a software testing configuration step may describe a custom text string that is configured to describe a particular action type with respect to a particular interactive page element. For example, in some embodiments, if the software testing operation that is associated with clicking on a button is associated with the custom text string abcdef, then a software testing configuration step that is associated with the noted software testing operation may have a step-wise token that describes the custom text string abcdef. In some embodiments, the step-wise tokens associated with software testing configuration steps of a software testing configuration data entity are combined to generate the software testing configuration tokenized representation for the noted software testing configuration data entity. For example, step-wise tokens associated with test case steps of a test case data entity may be combined to generate a software testing configuration tokenized representation for the noted test case data entity. As another example, step-wise tokens associated with test case steps of an automated testing workflow data entity may be combined to generate a software testing configuration tokenized representation for the noted automated testing workflow data entity.

At step/operation 903, the web server computing entity 106 generates a first token frequency data entity for the first software testing configuration data entity and a second token frequency data entity for the second software testing configuration data entity. In some embodiments, the web server computing entity 106 generates the first token frequency data entity for the first software testing configuration data entity based at least in part on the first software testing configuration tokenized representation for the first software testing configuration data entity. In some embodiments, the web server computing entity 106 generates the second token frequency data entity for the second software testing configuration data entity based at least in part on the second software testing configuration tokenized representation for the second software testing configuration data entity.

In some embodiments, a token frequency data entity describes a frequency measure for at least some of the step-wise tokens in a software testing configuration tokenized representation for a corresponding software testing configuration data entity. For example, in some embodiments, a token frequency data entity for a corresponding software testing configuration data entity is a bag of words data entity that describes a bag of words representation of the software testing configuration tokenized representation for the corresponding software testing configuration data entity. As another example, in some embodiments, a token frequency data entity for a corresponding software testing configuration data entity is an index token frequency data entity that describes, for each index token of a set of defined index tokens, a measure of frequency (e.g., an occurrence count) of the index token in the software testing configuration tokenized representation for the corresponding software testing configuration data entity. As yet another example, in some embodiments, a token frequency data entity for a corresponding software testing configuration data entity is an index token frequency data entity that describes, for each index token of a set of defined index tokens, a Term Frequency-Index Domain Frequency (TF-IDF) measure for the index token in the software testing configuration tokenized representation for the corresponding software testing configuration data entity relative to the software testing configuration tokenized representations of the software testing configuration data entity across a corpus of software of testing configuration data entities (e.g., across a corpus of existing software testing configuration data entities retrieved as part of training a software testing configuration data entity similarity determination machine learning framework, as further described herein).

At step/operation 904, the web server computing entity 106 generates a first low-dimensional tokenized representation for the first software testing configuration data entity and a second low-dimensional tokenized representation for the second software testing configuration data entity. In some embodiments, to generate the first low-dimensional tokenized representation for the first software testing configuration data entity, the web server computing entity 106 applies the rules/guidelines described by the dictionary file to the first token frequency data entity for the first software testing configuration data entity. In some embodiments, to generate the second low-dimensional tokenized representation for the second software testing configuration data entity, the web server computing entity 106 applies the rules/guidelines described by the dictionary file to the second token frequency data entity for the second software testing configuration data entity. In some embodiments, a dictionary file describes guidelines/rules that are configured to enable mapping token frequency data entities of software configuration data entities into low-dimensional tokenized representations of software configuration data entities. In some embodiments, a model file is a component of a software testing configuration data entity similarity determination machine learning framework. In some embodiments, an index file is generated by a latent semantic indexing routine.

In some embodiments, a low-dimensional tokenized representation may describe a dimensionally-reduced representation of a token frequency data entity for a corresponding software testing configuration data entity, such as a dimensionally-reduced representation of an index frequency for the corresponding software testing configuration data entity and/or a dimensionally-reduced representation of a bag of words data entity for the corresponding software testing configuration data entity. In some embodiments, determining a low-dimensional tokenized representation of a corresponding software testing configuration data entity includes determining an index token frequency data entity for the software testing configuration data entity, wherein the index token frequency data entity describes a token occurrence count for each index token of a plurality of index tokens across the first software testing configuration tokenized representation; and determining the low-dimensional tokenized representation based at least in part on the index token frequency data entity. In some of the noted embodiments, determining the low-dimensional tokenized representation based at least in part on the index token frequency data entity comprises applying latent semantic indexing to the index token frequency data entity in order to generate the low-dimensional tokenized representation. In some embodiments, determining a low-dimensional tokenized representation of a corresponding software testing configuration data entity includes determining a bag of words data entity for the software testing configuration data entity; and determining the low-dimensional tokenized representation based at least in part on the bag of words data entity. In some of the noted embodiments, determining the low-dimensional tokenized representation based at least in part on the bag of words data entity comprises applying latent semantic indexing to the bag of words data entity in order to generate the low-dimensional tokenized representation.

At step/operation 905, the web server computing entity 106 generates the predicted similarity score based at least in part on the first low-dimensional tokenized representation and the second low-dimensional tokenized representation. In some embodiments, determining the predicted similarity score comprises determining a first low-dimensional tokenized representation of the first software testing configuration tokenized representation; identifying a second low-dimensional tokenized representation of the second software testing configuration tokenized representation; and determining the predicted similarity score based at least in part on the first low-dimensional tokenized representation and the second low-dimensional tokenized representation. In some embodiments, determining the predicted similarity score based at least in part on the first low-dimensional tokenized representation and the second low-dimensional tokenized representation comprises determining the predicted similarity score based at least in part on a cosine similarity of the first low-dimensional tokenized representation and the second low-dimensional tokenized representation. In some embodiments, determining the predicted similarity score based at least in part on the first low-dimensional tokenized representation and the second low-dimensional tokenized representation comprises determining the predicted similarity score based at least in part on a dot product similarity of the first low-dimensional tokenized representation and the second low-dimensional tokenized representation.

At step/operation 906, the web server computing entity 106 performs one or more prediction-based actions based at least in part on the predicted similarity score. In some embodiments, performing the prediction-based actions includes performing the one or more prediction-based actions comprises, in response to determining that the predicted similarity score satisfies a predicted similarity score threshold, generating a similar configuration data entity set for the first software testing configuration data based at least in part on the defined-size subset, wherein data describing the similar configuration data entity set is configured to be displayed to an end user of a software testing platform. In some embodiments, performing the prediction-based actions comprises causing display to an end user of a prompt that enables the end user to select one or more software testing configuration data entities that are deemed to be similar to an input software testing configuration data entity, where selection of a software testing configuration data entity enables editing the software testing configuration data entity as part of the process for generating the input software testing configuration data entity and/or integrating the selected software testing configuration data entity into the input software testing configuration data entity during the generation process.

By utilizing the above-described techniques, various embodiments of the present invention describe techniques for reducing operational load on software testing platforms by enabling end users to use those software testing configuration data entities that are deemed similar to an input software testing configuration data entity. For example, various embodiments of the present invention provide techniques for comparing software testing configuration data entities that utilize software testing configuration tokenized representations of the noted software testing configuration data entities. By utilizing the noted techniques, various embodiments of the present invention enable generating a prompt to an end user that enables the end user to edit a software testing configuration data entity that is deemed similar to the input software testing configuration entity. By doing so, the end user will generate fewer operations that the software testing platform is configured to handle, a feature that in turn reduces the operational load on the software testing platform.

Moreover, various embodiments of the present invention enable generating more reliable software testing configuration data entities, which in turn reduces the number of erroneous testing operations performed using the noted software testing configuration data entities. In some embodiments, by reducing the number of erroneous testing operations by generating more reliable software testing configuration data entities, various embodiments of the present invention improve the operational efficiency of test automation platforms by reducing the number of processing operations that need to be executed by the noted test automation platforms in order to enable software testing operations (e.g., automated software testing operations). By reducing the number of processing operations that need to be executed by the noted test automation platforms in order to execute software testing operations, various embodiments of the present invention make important technical contributions to the field of software application testing. Accordingly, by enhancing the accuracy and reliability of automated testing workflow data entities generated by software testing engineers, the user-friendly and intuitive automated testing workflow generation techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for determining a predicted similarity score for a first software testing configuration data entity and a second software testing configuration data entity, the computer-implemented method comprising:
determining, using a processor, a first software testing configuration tokenized representation for the first software testing configuration data entity, wherein the first software testing configuration tokenized representation comprises one or more first step-wise tokens for one or more first software testing configuration steps of the first software testing configuration data entity;
identifying, using the processor, a second software testing configuration tokenized representation for the second software testing configuration data entity, wherein the second software testing configuration tokenized representation comprises one or more second step-wise tokens for one or more second software testing configuration steps of the second software testing configuration data entity;
determining, using the processor, the predicted similarity score based at least in part on the first software testing configuration tokenized representation and the second software testing configuration tokenized representation; and
performing, using the processor, one or more prediction-based actions based at least in part on the predicted similarity score.

2. The computer-implemented method of claim 1, wherein:
the second software testing configuration data entity is selected from a plurality of indexed software testing configuration data entities;
the plurality of indexed software testing configuration data entities are associated with an index file; and
the index file describes, for each particular indexed software testing configuration data entity, a defined-size subset of the plurality of indexed software testing configuration data entities other than the particular indexed software testing configuration data entity that are deemed most similar to the particular indexed software testing configuration data entity.

3. The computer-implemented method of claim 2, wherein performing the one or more prediction-based actions comprises:
in response to determining that the predicted similarity score satisfies a predicted similarity score threshold, generating a similar configuration data entity set for the first software testing configuration data based at least in part on the defined-size subset, wherein data describing the similar configuration data entity set is configured to be displayed to an end user of a software testing platform.

4. The computer-implemented method of claim 1, wherein determining the predicted similarity score comprises:
determining a first low-dimensional tokenized representation of the first software testing configuration tokenized representation;
identifying a second low-dimensional tokenized representation of the second software testing configuration tokenized representation; and
determining the predicted similarity score based at least in part on the first low-dimensional tokenized representation and the second low-dimensional tokenized representation.

5. The computer-implemented method of claim 4, wherein determining the first low-dimensional tokenized representation comprises:
determining an index token frequency data entity for the first software testing configuration tokenized representation, wherein the index token frequency data entity describes a token occurrence count for each index token of a plurality of index tokens across the first software testing configuration tokenized representation; and
determining the first low-dimensional tokenized representation based at least in part on the index token frequency data entity.

6. The computer-implemented method of claim 5, wherein determining the first low-dimensional tokenized representation comprises:
determining a bag of words data entity for the first software testing configuration tokenized representation; and
determining the first low-dimensional tokenized representation based at least in part on the bag of words data entity.

7. The computer-implemented method of claim 4, wherein:
the second software testing configuration data entity is selected from a plurality of existing software testing configuration data entities;
the plurality of existing software testing configuration data entities are associated with a dictionary file that is configured to enable mapping each software testing configuration tokenized representation for the plurality of modeled software testing configuration data entities to a corresponding low-dimensional tokenized representation;
determining the first low-dimensional tokenized representation is performed by using the dictionary file in relation to the first software testing configuration tokenized representation.

8. The computer-implemented method of claim 4, wherein determining the predicted similarity score based at least in part on the first low-dimensional tokenized representation and the second low-dimensional tokenized representation comprises:
determining the predicted similarity score based at least in part on a cosine similarity of the first low-dimensional tokenized representation and the second low-dimensional tokenized representation.

9. The computer-implemented method of claim 4, wherein determining the predicted similarity score based at least in part on the first low-dimensional tokenized representation and the second low-dimensional tokenized representation comprises:
determining the predicted similarity score based at least in part on a dot product similarity of the first low-dimensional tokenized representation and the second low-dimensional tokenized representation.

10. An apparatus for determining a predicted similarity score for a first software testing configuration data entity and a second software testing configuration data entity, the apparatus comprising at least one processor and at least one memory including program code, the at least one memory and the program code configured to, with the processor, cause the apparatus to at least:
determine a first software testing configuration tokenized representation for the first software testing configuration data entity, wherein the first software testing configuration tokenized representation comprises one or more first step-wise tokens for one or more first software testing configuration steps of the first software testing configuration data entity;
identify a second software testing configuration tokenized representation for the second software testing configuration data entity, wherein the second software testing configuration tokenized representation comprises one or more second step-wise tokens for one or more second software testing configuration steps of the second software testing configuration data entity;
determine the predicted similarity score based at least in part on the first software testing configuration tokenized representation and the second software testing configuration tokenized representation; and
perform one or more prediction-based actions based at least in part on the predicted similarity score.

11. The apparatus of claim 10, wherein:
the second software testing configuration data entity is selected from a plurality of indexed software testing configuration data entities;
the plurality of indexed software testing configuration data entities are associated with an index file; and
the index file describes, for each particular indexed software testing configuration data entity, a defined-size subset of the plurality of indexed software testing configuration data entities other than the particular indexed software testing configuration data entity that are deemed most similar to the particular indexed software testing configuration data entity.

12. The apparatus of claim 11, wherein performing the one or more prediction-based actions comprises:
in response to determining that the predicted similarity score satisfies a predicted similarity score threshold, generating a similar configuration data entity set for the first software testing configuration data based at least in part on the defined-size subset, wherein data describing the similar configuration data entity set is configured to be displayed to an end user of a software testing platform.

13. The apparatus of claim 10, wherein determining the predicted similarity score comprises:
determining a first low-dimensional tokenized representation of the first software testing configuration tokenized representation;
identifying a second low-dimensional tokenized representation of the second software testing configuration tokenized representation; and
determining the predicted similarity score based at least in part on the first low-dimensional tokenized representation and the second low-dimensional tokenized representation.

14. The apparatus of claim 10, wherein determining the first low-dimensional tokenized representation comprises:
determining an index token frequency data entity for the first software testing configuration tokenized representation, wherein the index token frequency data entity describes a token occurrence count for each index token of a plurality of index tokens across the first software testing configuration tokenized representation; and
determining the first low-dimensional tokenized representation based at least in part on the index token frequency data entity.

15. The apparatus of claim 14, wherein determining the first low-dimensional tokenized representation comprises:
determining a bag of words data entity for the first software testing configuration tokenized representation; and
determining the first low-dimensional tokenized representation based at least in part on the bag of words data entity.

16. The apparatus of claim 13, wherein:
the second software testing configuration data entity is selected from a plurality of existing software testing configuration data entities;
the plurality of existing software testing configuration data entities are associated with a dictionary file that is configured to enable mapping each software testing configuration tokenized representation for the plurality of modeled software testing configuration data entities to a corresponding low-dimensional tokenized representation;
determining the first low-dimensional tokenized representation is performed by using the dictionary file in relation to the first software testing configuration tokenized representation.

17. The apparatus of claim 13, wherein determining the predicted similarity score based at least in part on the first low-dimensional tokenized representation and the second low-dimensional tokenized representation comprises:
determining the predicted similarity score based at least in part on a cosine similarity of the first low-dimensional tokenized representation and the second low-dimensional tokenized representation.

18. The apparatus of claim 13, wherein determining the predicted similarity score based at least in part on the first low-dimensional tokenized representation and the second low-dimensional tokenized representation comprises:
determining the predicted similarity score based at least in part on a dot product similarity of the first low-dimensional tokenized representation and the second low-dimensional tokenized representation.

19. A computer program product for determining a predicted similarity score for a first software testing configuration data entity and a second software testing configuration data entity, the computer program product comprising at least one non-transitory computer-readable storage medium having computer-readable program code portions stored therein, the computer-readable program code portions configured to:
determine a first software testing configuration tokenized representation for the first software testing configuration data entity, wherein the first software testing configuration tokenized representation comprises one or more first step-wise tokens for one or more first software testing configuration steps of the first software testing configuration data entity;
identify a second software testing configuration tokenized representation for the second software testing configuration data entity, wherein the second software testing configuration tokenized representation comprises one or more second step-wise tokens for one or more second software testing configuration steps of the second software testing configuration data entity;
determine the predicted similarity score based at least in part on the first software testing configuration tokenized representation and the second software testing configuration tokenized representation; and
perform one or more prediction-based actions based at least in part on the predicted similarity score.

20. The computer program product of claim 19, wherein:
the second software testing configuration data entity is selected from a plurality of indexed software testing configuration data entities;
the plurality of indexed software testing configuration data entities are associated with an index file; and
the index file describes, for each particular indexed software testing configuration data entity, a defined-size subset of the plurality of indexed software testing configuration data entities other than the particular indexed software testing configuration data entity that are deemed most similar to the particular indexed software testing configuration data entity.
